(19) United States
(12) Patent Application Publication
(10) Pub. No.: US 2012/0139327 A1
(43) Pub. Date: Jun. 7, 2012

(54) Bicycle Hub Assembly

(76) Inventor: Ching-Shu Chen, Changhua City (TW)

(21) Appl. No.: 12/958,463

(22) Filed: Dec. 2, 2010

(51) Int. Cl. B60B 27/00

(52) U.S. Cl. 301/110.5

(57) ABSTRACT

A hub assembly for a bicycle includes a hub, a drive seat arranged on the hub, a protective bushing mounted on the drive seat, and a freewheel unit mounted on the protective bushing. The drive seat has an outer periphery provided with a plurality of positioning ribs. The protective bushing has an inner periphery provided with a plurality of positioning grooves forcibly fitted onto the positioning ribs and has an outer periphery provided with a plurality of reinforcing ribs each surrounding the respective positioning groove. Thus, the positioning ribs of the drive seat are reinforced by the reinforcing ribs of the protective bushing so that when the drive seat is subjected to a torque which is applied by the rotating freewheel unit, the positioning ribs can withstand the torque without producing distortion or wear.

### BACKGROUND OF THE INVENTION

1. Field of the Invention

The present invention relates to a hub assembly and, more particularly, to a rear hub assembly for a bicycle.

2. Description of the Related Art

A conventional hub assembly for a bicycle in accordance with the prior art shown in FIGS. 7-9 comprises a drive seat 50, a plurality of positioning ribs 51 formed on the drive seat 50, a plurality of reinforcing ribs 70 mounted on the drive seat 50, and a freewheel unit 80 mounted on the drive seat 50 and locked by the positioning ribs 51 and the reinforcing ribs 70. The positioning ribs 51 and the reinforcing ribs 70 are arranged in a staggered manner. Each of the reinforcing ribs 70 includes an elongate protruding block 52 and a protective bar 60 combined with the protruding block 52. The protruding block 52 of each of the reinforcing ribs 70 is formed with at least one locking groove 53 for locking the protective bar 60. However, the protective bar 60 is partially locked by the locking groove 53 of the protruding block 52 so that the protective bar 60 is easily detached from the protruding block 52 to decrease the strength of each of the reinforcing ribs 70. In addition, it is necessary to insert the protective bar 60 onto the locking groove 53 of the protruding block 52, thereby complicating assembly of the conventional hub assembly, and thereby increasing the cost of fabrication. Further, the drive seat 50 has a greater weight by provision of the protective bar 60, thereby increasing the weight of the conventional hub assembly.

### BRIEF SUMMARY OF THE INVENTION

In accordance with the present invention, there is provided a hub assembly for a bicycle, comprising a hub, a drive seat arranged on a side of the hub, a protective bushing mounted on the drive seat to cover the drive seat, a freewheel unit mounted on the protective bushing, and a locking ring locked onto the drive seat and abutting the freewheel unit. The drive seat has an outer periphery provided with a plurality of positioning ribs. The drive seat has a side provided with a stop flange to stop the protective bushing. The drive seat has an inner periphery provided with an inner threaded portion. The protective bushing has an inner periphery provided with a plurality of positioning grooves forcibly fitted onto the positioning ribs of the drive seat. The protective bushing has an outer periphery provided with a plurality of reinforcing ribs each surrounding a respective one of the positioning grooves and each corresponding to a respective one of the positioning ribs of the drive seat. The freewheel unit has an inner periphery provided with a shaft hole mounted on the protective bushing. The locking ring has a side provided with an outer threaded portion screwed onto the inner threaded portion of the drive seat and has an outer periphery provided with a stop rim abutting the freewheel unit to limit the freewheel unit on the protective bushing.

According to the primary advantage of the present invention, the positioning ribs of the drive seat are covered and reinforced by the reinforcing ribs of the protective bushing to have greater strength and stiffness so that when the drive seat and the protective bushing are subjected to a torque which is applied by the rotating freewheel unit, the positioning ribs of the drive seat can withstand the torque transmitted by the freewheel unit without producing distortion or wear so as to enhance the lifetime of the drive seat.

According to another advantage of the present invention, the positioning grooves of the protective bushing are directly fitted onto the positioning ribs of the drive seat so that the protective bushing is mounted on the drive seat easily and quickly to facilitate assembly of the hub assembly.

According to a further advantage of the present invention, the protective bushing is forcibly fitted onto the drive seat without producing a clearance therebetween so that the protective bushing is combined with the drive seat closely and precisely.

According to a further advantage of the present invention, the protective bushing is molded and formed integrally to decrease the cost of fabrication of the hub assembly.

According to a further advantage of the present invention, the positioning ribs of the drive seat are reinforced by the reinforcing ribs of the protective bushing to withstand a larger torque so that the number of the positioning ribs of the drive seat can be reduced efficiently so as to reduce the weight of the drive seat.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a hub assembly for a bicycle in accordance with the preferred embodiment of the present invention.

FIG. 2 is an exploded perspective view of the hub assembly for a bicycle as shown in FIG. 1.

FIG. 3 is a side cross-sectional view of the hub assembly for a bicycle as shown in FIG. 1.

FIG. 4 is an exploded perspective view of the hub assembly for a bicycle in accordance with the preferred embodiment of the present invention.

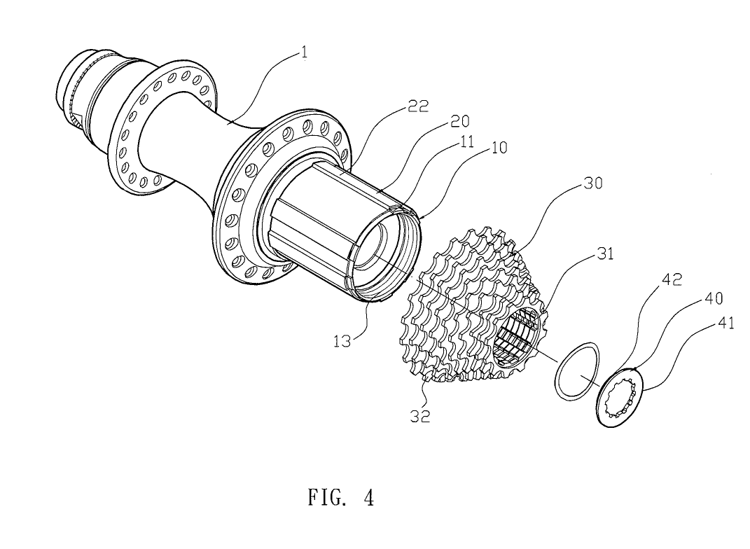

FIG. 5 is a side cross-sectional view of the hub assembly for a bicycle as shown in FIG. 4.

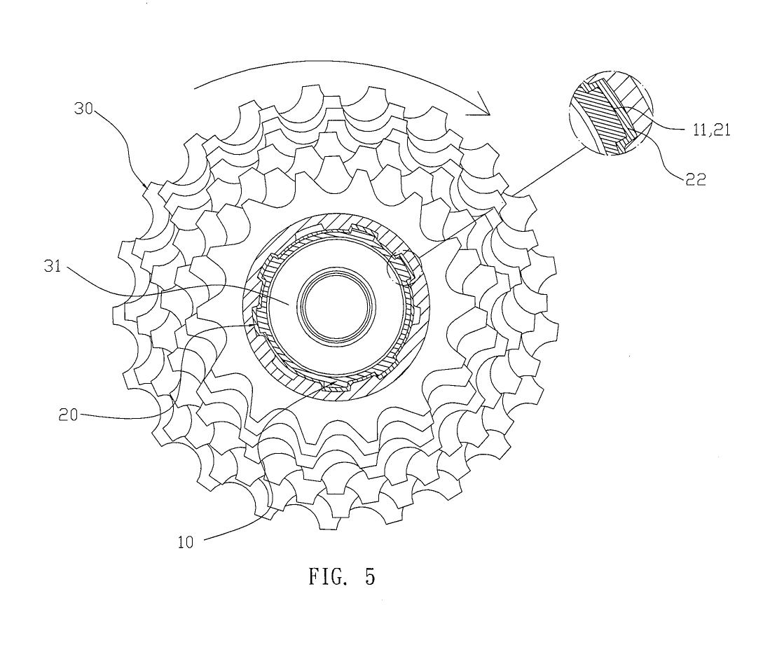

FIG. 6 is a partially exploded perspective view of a hub assembly for a bicycle in accordance with another preferred embodiment of the present invention.

FIG. 7 is a perspective view of a conventional hub assembly for a bicycle in accordance with the prior art.

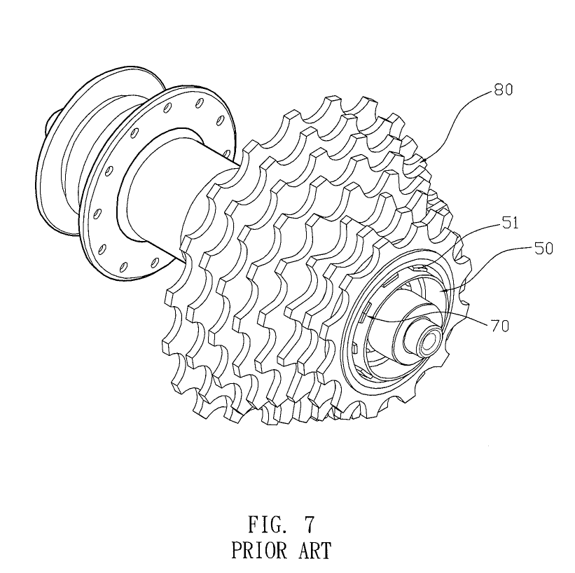

FIG. 8 is a partially exploded perspective view of the conventional hub assembly for a bicycle as shown in FIG. 7.

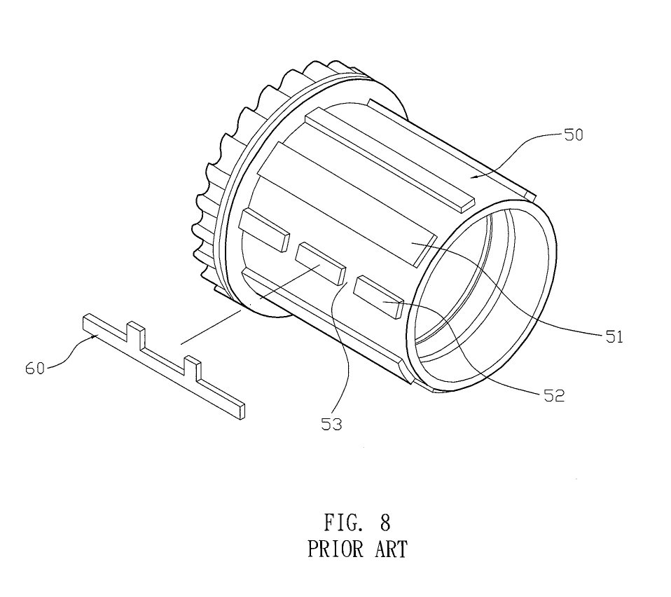

FIG. 9 is a side cross-sectional assembly view of the conventional hub assembly for a bicycle as shown in FIG. 8.

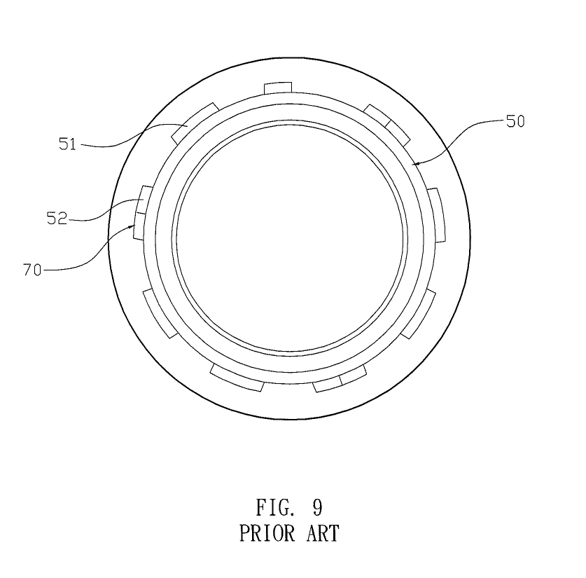

### DETAILED DESCRIPTION OF THE INVENTION

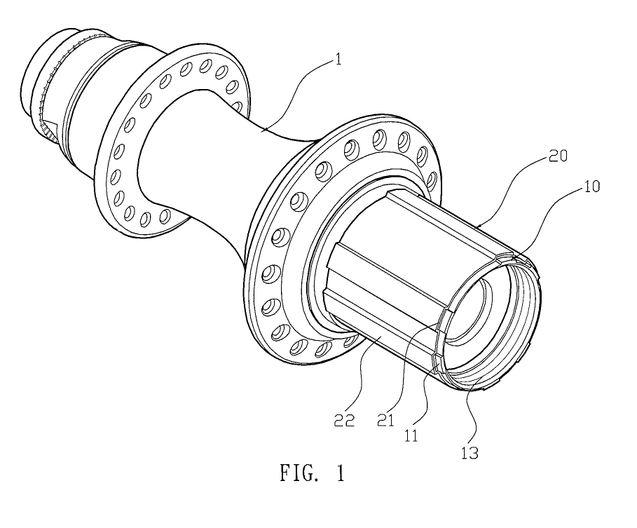

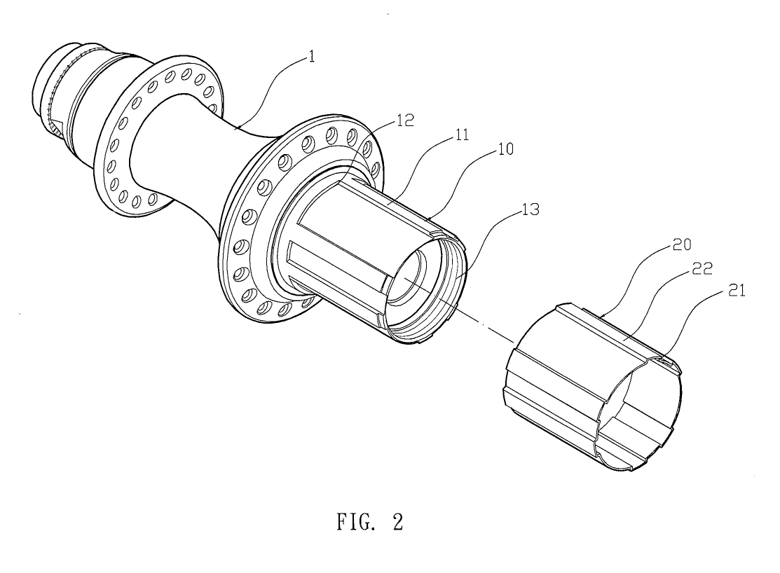

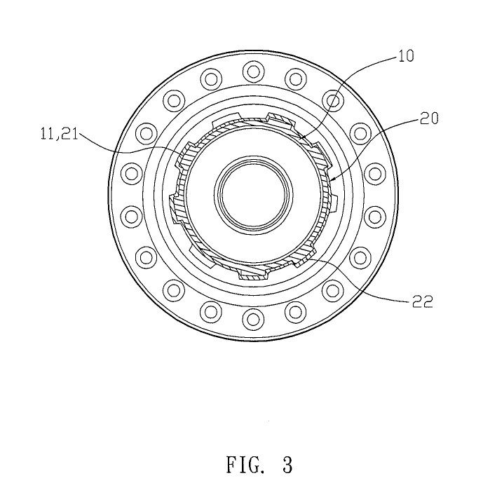

Referring to the drawings and initially to FIGS. 1-3, a hub assembly for a bicycle in accordance with the preferred embodiment of the present invention comprises a hub 1, a drive seat 10 arranged on a side of the hub 1, a protective bushing 20 mounted on the drive seat 10 to cover the drive seat 10, a freewheel unit 30 mounted on the protective bushing 20, and a locking ring 40 locked onto the drive seat 10 and abutting the freewheel unit 30.

The drive seat 10 is made of aluminum alloy and has a cylindrical shape. The drive seat 10 has an outer periphery provided with a plurality of positioning ribs 11. The positioning ribs 11 of the drive seat 10 extend in a longitudinal direction of the drive seat 10 and are arranged in an annular manner. The drive seat 10 has a side provided with a stop flange 12 to stop the protective bushing 20. The stop flange 12 of the drive seat 10 is located between the hub 1 and the positioning ribs 11 of the drive seat 10. The drive seat 10 has an inner periphery provided with an inner threaded portion 13. The drive seat 10 is located between the hub 1 and the locking ring 40 and has a first end formed with the stop flange 12 and a second end formed with the inner threaded portion 13.

The protective bushing 20 is a thin tube having a great stiffness. Preferably, the protective bushing 20 is made of iron alloy. The protective bushing 20 is molded and formed integrally and has a shape matching that of the drive seat 10. The protective bushing 20 has an inner periphery provided with a plurality of positioning grooves 21 forcibly fitted onto the positioning ribs 11 of the drive seat 10. The positioning grooves 21 of the protective bushing 20 extend in a longitudinal direction of the protective bushing 20 and are arranged in an annular manner. The protective bushing 20 is located between the hub 1 and the locking ring 40 and has a side stopped by the stop flange 12 of the drive seat 10. The protective bushing 20 has an outer periphery provided with a plurality of reinforcing ribs 22 each surrounding a respective one of the positioning grooves 21 and each corresponding to a respective one of the positioning ribs 11 of the drive seat 10. The reinforcing ribs 22 of the protective bushing 20 extend in a longitudinal direction of the protective bushing 20 and are arranged in an annular manner.

The freewheel unit 30 is located between the hub 1 and the locking ring 40. The freewheel unit 30 includes at least one freewheel 32 and has an inner periphery provided with a shaft hole 31 mounted on the protective bushing 20. The shaft hole 31 of the freewheel unit 30 has a shape matching that of the protective bushing 20 so that the shaft hole 31 of the freewheel unit 30 is positioned on the protective bushing 20.

The locking ring 40 has a side provided with an outer threaded portion 42 screwed onto the inner threaded portion 13 of the drive seat 10 and has an outer periphery provided with a stop rim 41 abutting the freewheel unit 30 to limit the freewheel unit 30 on the protective bushing 20.

In assembly, the hub 1 is connected to a wheel (not shown) of the bicycle and is rotatably mounted on a shaft (not shown), the shaft is connected to the rear stays (not shown) of a frame (not shown) of the bicycle, and the freewheel unit 30 on the drive seat 10 meshes with and is driven by a chain (not shown) which is driven by a chainwheel (not shown) which is driven by a pedal (not shown) that is pedalled by a rider.

In operation, when the pedal is pedalled by a rider, the chainwheel is driven by the pedal to drive the chain which drives the freewheel unit 30 so as to drive the drive seat 10, so that the drive seat 10 is rotated to drive and rotate the hub 1 relative to the shaft 12 so as to move the wheel and to move the bicycle forward.

In such a manner, the positioning ribs 11 of the drive seat 10 are covered and reinforced by the reinforcing ribs 22 of the protective bushing 20 to have greater strength and stiffness so that when the drive seat 10 and the protective bushing 20 are subjected to a torque which is applied by the rotating freewheel unit 30, the positioning ribs 11 of the drive seat 10 can withstand the torque transmitted by the freewheel unit 30 without producing distortion or wear so as to enhance the lifetime of the drive seat 10. In addition, the positioning grooves 21 of the protective bushing 20 are directly fitted onto the positioning ribs 11 of the drive seat 10 so that the protective bushing 20 is mounted on the drive seat 10 easily and quickly to facilitate assembly of the hub assembly. Further, the protective bushing 20 is forcibly fitted onto the drive seat 10 without producing a clearance therebetween so that the protective bushing 20 is combined with the drive seat 10 closely and precisely. Further, the protective bushing 20 is molded and formed integrally to decrease the cost of fabrication of the hub assembly. Further, the positioning ribs 11 of the drive seat 10 are reinforced by the reinforcing ribs 22 of the protective bushing 20 to withstand a larger torque so that the number of the positioning ribs 11 of the drive seat 10 can be reduced efficiently so as to reduce the weight of the drive seat 10.

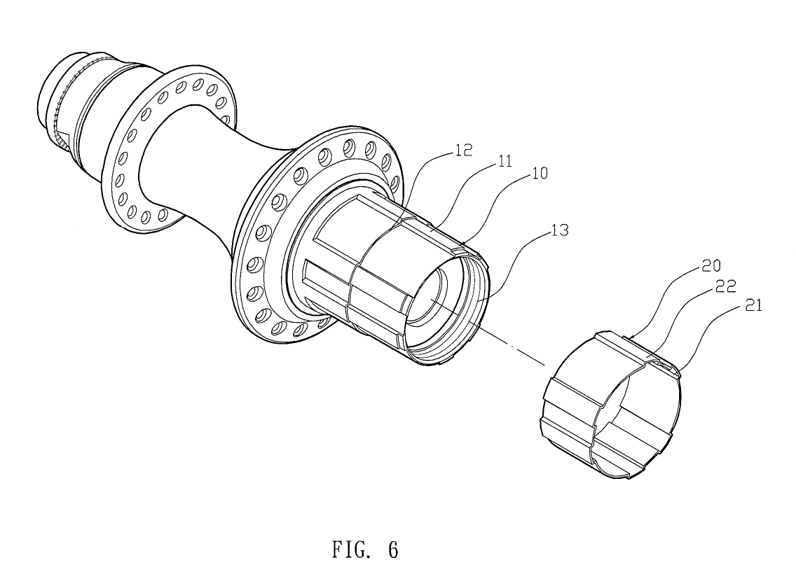

Referring to FIG. 6, the length of each of the positioning ribs 11 of the drive seat 10 can be adjusted to correspond to that of the freewheel unit (not shown), and the length of each of the reinforcing ribs 22 of the protective bushing 20 can also be adjusted. In addition, the position of the stop flange 12 of the drive seat 10 can also be adjusted.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A hub assembly for a bicycle, comprising:
a hub;
a drive seat arranged on a side of the hub;
a protective bushing mounted on the drive seat to cover the drive seat;
a freewheel unit mounted on the protective bushing; and
a locking ring locked onto the drive seat and abutting the freewheel unit;
wherein the drive seat has an outer periphery provided with a plurality of positioning ribs;
the drive seat has a side provided with a stop flange to stop the protective bushing;
the drive seat has an inner periphery provided with an inner threaded portion;
the protective bushing has an inner periphery provided with a plurality of positioning grooves forcibly fitted onto the positioning ribs of the drive seat;
the protective bushing has an outer periphery provided with a plurality of reinforcing ribs each surrounding a respective one of the positioning grooves and each corresponding to a respective one of the positioning ribs of the drive seat;
the freewheel unit has an inner periphery provided with a shaft hole mounted on the protective bushing;
the locking ring has a side provided with an outer threaded portion screwed onto the inner threaded portion of the drive seat;
the locking ring has an outer periphery provided with a stop rim abutting the freewheel unit to limit the freewheel unit on the protective bushing.

2. The hub assembly for a bicycle of claim 1, wherein
the drive seat is made of aluminum alloy and has a cylindrical shape;
the protective bushing is a thin tube having a great stiffness;
the protective bushing is molded and formed integrally and has a shape matching that of the drive seat;
the shaft hole of the freewheel unit has a shape matching that of the protective bushing so that the shaft hole of the freewheel unit is positioned on the protective bushing.

3. The hub assembly for a bicycle of claim 1, wherein
the positioning ribs of the drive seat are covered and reinforced by the reinforcing ribs of the protective bushing to have greater strength and stiffness so that when the drive seat and the protective bushing are subjected to a torque which is applied by the rotating freewheel unit, the positioning ribs of the drive seat can withstand the torque transmitted by the freewheel unit;
the positioning grooves of the protective bushing are directly fitted onto the positioning ribs of the drive seat so that the protective bushing is mounted on the drive seat easily and quickly;
the protective bushing is forcibly fitted onto the drive seat without producing a clearance therebetween so that the protective bushing is combined with the drive seat closely and precisely;
the positioning ribs of the drive seat are reinforced by the reinforcing ribs of the protective bushing to withstand a larger torque so that a number of the positioning ribs of the drive seat can be reduced so as to reduce a weight of the drive seat.

4. The hub assembly for a bicycle of claim 1, wherein the protective bushing is made of iron alloy.

5. The hub assembly for a bicycle of claim 1, wherein
each of the positioning ribs of the drive seat has a length that is adjustable to correspond to that of the freewheel unit;
each of the reinforcing ribs of the protective bushing has a length that is adjustable;
the stop flange of the drive seat has a position that is adjustable.

6. The hub assembly for a bicycle of claim 1, wherein
the positioning ribs of the drive seat extend in a longitudinal direction of the drive seat and are arranged in an annular manner;
the stop flange of the drive seat is located between the hub and the positioning ribs of the drive seat;
the drive seat is located between the hub 1 and the locking ring and has a first end formed with the stop flange and a second end formed with the inner threaded portion;
the positioning grooves of the protective bushing extend in a longitudinal direction of the protective bushing and are arranged in an annular manner;
the protective bushing is located between the hub and the locking ring and has a side stopped by the stop flange of the drive seat;
the reinforcing ribs of the protective bushing extend in a longitudinal direction of the protective bushing and are arranged in an annular manner;
the freewheel unit is located between the hub and the locking ring.
